(19) United States
(12) Patent Application Publication
(10) Pub. No.: US 2002/0134192 A1
(43) Pub. Date: Sep. 26, 2002

(54) Bicycle pedal with a light-generating capability

(76) Inventor: Chih-Jung Chang, Chiayi Hsien (TW)

Correspondence Address: COOK, ALEX, McFARRON, MANZO, CUMMINGS & MEHLER, LTD., Suite 2850, 200 West Adams Street, Chicago, IL, 60606, US

(21) Appl. No.: 09/814,448

(22) Filed: Mar. 22, 2001

(51) Int. Cl. B62M 3/12

(52) U.S. Cl. 74/594.4

(57) ABSTRACT

A bicycle pedal includes a pedal body, an axle and a light-generating unit. The pedal body is formed with a tubular axle sleeve having an axle hole, a cage member disposed around and connected to the axle sleeve, and a generator chamber adjacent to one of front and rear ends of the axle hole. The axle extends into the axle hole, is coupled rotatably to the axle sleeve, and is formed with a wheel-mounting portion that is disposed in the generator chamber. The light-generating unit includes a magnet wheel disposed in the generator chamber and mounted coaxially and co-rotatably on the wheel-mounting portion of the axle, a coil device disposed in the generator chamber around the magnet wheel and mounted on the pedal body, and a lamp unit connected electrically to the coil device and mounted on the cage member.

### BACKGROUND OF THE INVENTION

1. Field of the Invention

The invention relates to a bicycle pedal, more particularly to a bicycle pedal with a light-generating capability.

2. Description of the Related Art

It is known in the art to provide a bicycle pedal with a light-reflective strip for enhanced safety when driving at night. However, the light-reflective strip will be able to serve its alerting purpose only when a light beam is radiated thereon. In addition, the light-reflective strip is likely to fall off or be covered with dirt after long-term use.

### SUMMARY OF THE INVENTION

Therefore, the main object of the present invention is to provide a bicycle pedal with a light-generating capability to overcome the aforesaid drawbacks associated with the use of light-reflective strips.

According to the present invention, a bicycle pedal comprises a pedal body, an axle and a light-generating unit. The pedal body is formed with a tubular axle sleeve having an axle hole with front and rear ends, a cage member disposed around and connected to the axle sleeve, and a generator chamber adjacent to one of the front and rear ends of the axle hole. The axle extends into the axle hole, is coupled rotatably to the axle sleeve, and is formed with a wheel-mounting portion that is disposed in the generator chamber. The light-generating unit includes a magnet wheel disposed in the generator chamber and mounted coaxially and co-rotatably on the wheel-mounting portion of the axle, a coil device disposed in the generator chamber around the magnet wheel and mounted on the pedal body, and a lamp unit connected electrically to the coil device and mounted on the cage member. Rotation of the axle relative to the pedal body results in rotation of the magnet wheel relative to the coil device, thereby inducing electrical currents in the coil device that are provided to the lamp unit so as to enable the lamp unit to generate a light output.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view showing the first preferred embodiment of a bicycle pedal according to the present invention when mounted on one end of a crank;

FIG. 2 is an exploded perspective view of the first preferred embodiment;

FIG. 3 is a partly sectional schematic view of the first preferred embodiment; and

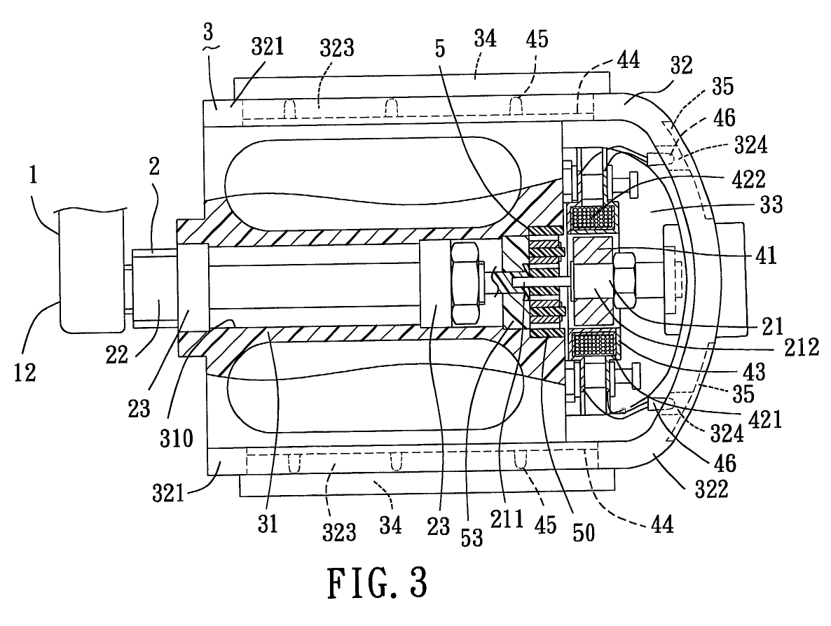

FIG. 4 is a partly sectional schematic view of the second preferred embodiment of a bicycle pedal according to the present invention.

### DETAILED DESCRIPTION OF THE PREFERRED EMBODIMENTS

Before the present invention is described in greater detail in connection with the following preferred embodiments, it should be noted that like elements are denoted by the same reference numerals throughout the disclosure.

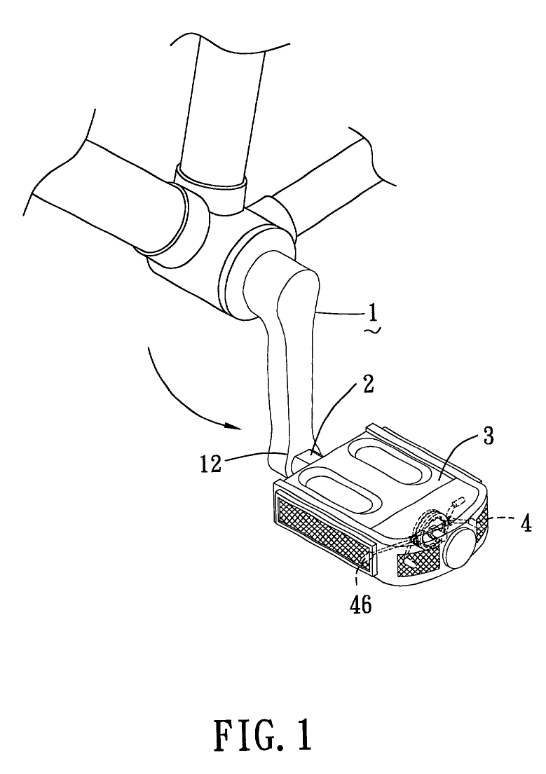

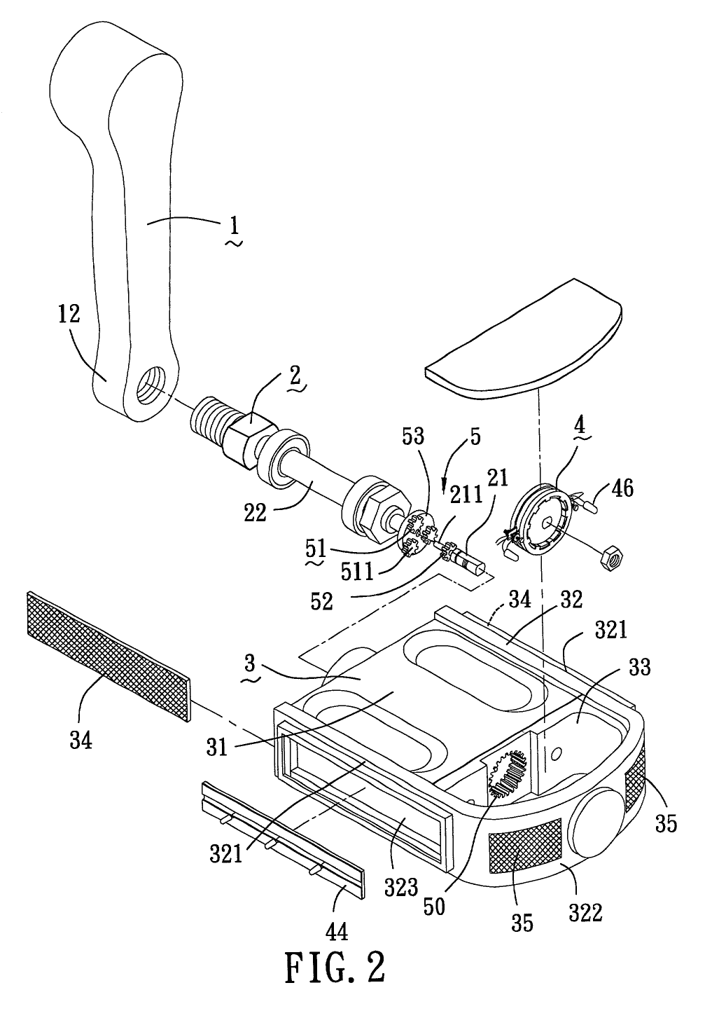

Referring to FIGS. 1 and 2, the first preferred embodiment of a bicycle pedal according to the present invention is shown to be adapted to be mounted on one end portion 12 of a crank 1. The bicycle pedal includes a pedal body 3, an axle 2, a light-generating unit 4, and a speed-increasing mechanism 5.

The pedal body 3 is formed with a tubular axle sleeve 31 having an axle hole 310 with front and rear ends, a cage member 32 disposed around and connected to the axle sleeve 31, and a generator chamber 33 adjacent to one of the front and rear ends of the axle hole 310. In this embodiment, the generator chamber 33 is disposed adjacent to the front end of the axle hole 310. The cage member 32 cooperates with the axle sleeve 31 to confine the generator chamber 33, and includes a pair of lateral cage portions 321 that extend parallel to the axle sleeve 31, that are disposed respectively on opposite lateral sides of the axle sleeve 31, and that have opposite front and rear ends connected to the axle sleeve 31, and a curved bridging portion 322 that interconnects the front ends of the lateral cage portions 321. Each of the lateral cage portions 321 has an outer wall surface formed with a board receiving cavity 323. The bridging portion 322 is formed with a pair of lamp-mounting holes 324.

The axle 2 extends into the axle hole 310 and is coupled rotatably to the axle sleeve 31. The axle 2 is formed with a wheel-mounting portion 21 that is disposed in the generator chamber 33. In this embodiment, the axle 2 is further formed with a coupling portion 22 having a first end part that extends out of the rear end of the axle hole 310 and that is adapted to be connected securely to the end portion 12 of the crank 1, and a second end part that is opposite to the first end part, that extends into the axle hole 310 and that is coupled rotatably to the axle sleeve 31 by means of a pair of bearings 23. The wheel-mounting portion 21 has a retaining section 211 coupled to the second end part of the coupling portion 22, and a supporting section 212 extending out of the front end of the axle hole 310 and into the generator chamber 33. In this embodiment, the retaining section 211 of the wheel-mounting portion 21 is inserted into an axial blind hole formed in the second end part of the coupling portion 22 for coupling rotatably and coaxially with the latter.

The light-generating unit 4 includes a permanent magnet wheel 41, a coil device formed from an annular coil seat 421 and a coil 422 wound on the coil seat 421, and a lamp unit. The magnet wheel 41 is disposed in the generator chamber 33 and is mounted coaxially and co-rotatably on the wheel-mounting portion 21 of the axle 2. The coil device is disposed in the generator chamber 33 around the magnet wheel 41. The coil device is enclosed by an annular casing 43, which is mounted on the pedal body 3. The lamp unit is connected electrically to the coil device, and is mounted on the cage member 32. In the preferred embodiment, the lamp unit includes a pair of circuit boards 44, each of which is received in a respective one of the board receiving cavities 323 in the outer wall surfaces of the lateral cage portions 321, a plurality of first lamps 45 mounted on the circuit boards 44, and a pair of second lamps 46 mounted respectively in the lamp-mounting holes 324. A first light-transmissive cover plate 34 is mounted on the outer wall surface of each of the lateral cage portions 321 to cover the board receiving cavities 323. A pair of second light-transmissive cover plates 35 are mounted on the bridging portion 322 to close one end of the lamp-mounting holes 324, respectively.

In the present embodiment, the speed-increasing mechanism 5 includes a set of gear teeth 50 formed in the front end of the axle hole 310, a sun gear 52 mounted securely and coaxially on the retaining section 211 of the wheel-mounting portion 21, a planet gear carrier 53 in the form of a radial outward annular flange mounted on the second end part of the coupling portion 22, and a planet gear set 51 including three planet gears 511 mounted rotatably on the planet gear carrier 53, angularly spaced apart from each other, and meshing with the gear teeth 50 and the sun gear 52. Preferably, the gear ratio of the gear teeth 50 to the sun gear 52 is 4:1. Thus, one complete revolution of the gear teeth 50 will result in four revolutions of the sun gear 52.

In use, rotation of the crank 1 will result in rotation of the axle 2 relative to the pedal body 3, thereby rotating the magnet wheel 41 relative to the coil device. As such, electrical currents are induced in the coil device and are provided to the lamp unit so as to enable the lamps 45, 46 to generate a light output. Because alternating currents are induced in the coil device, a flashing light output will be generated by the lamps 45, 46 for enhanced safety when driving at night.

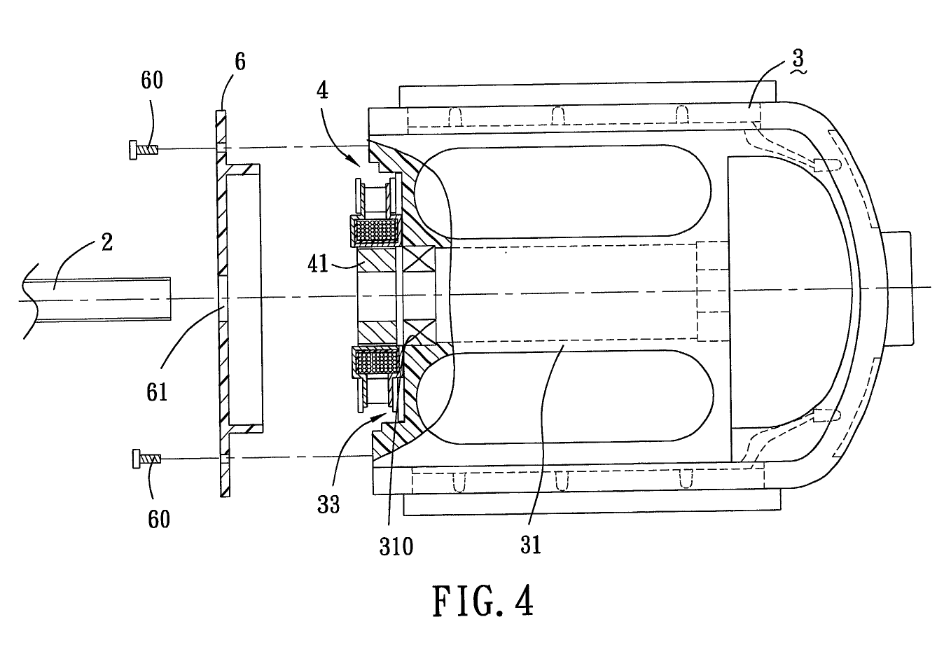

FIG. 4 illustrates the second preferred embodiment of a bicycle pedal according to this invention. Unlike the previous embodiment, the generator chamber 33 is formed adjacent to the rear end of the axle hole 310. The axle 2 is formed with a pedal coupling portion that extends into the axle hole 310 and that is coupled rotatably to the axle sleeve 31 by means of a pair of bearings 23. The wheel-mounting portion of the axle 2 extends rearwardly and coaxially from the pedal coupling portion so as to extend out of the rear end of the axle hole 310 and into the generator chamber 33. The axle 2 is further formed with a crank coupling portion that extends rearwardly and coaxially from the pedal coupling portion and that is adapted to be secured to the end portion 12 of the crank 1 (see FIG. 1). A cover plate 6 is mounted on the pedal body 3 by means of screws 60 to conceal the magnet wheel 41 and the coil device of the light-generating unit 4. The cover plate 6 is formed with an axle opening 61 for extension of the crank coupling portion of the axle 2 therethrough.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A bicycle pedal, comprising:
a pedal body formed with a tubular axle sleeve having an axle hole with front and rear ends, a cage member disposed around and connected to said axle sleeve, and a generator chamber adjacent to one of said front and rear ends of said axle hole;
an axle extending into said axle hole and coupled rotatably to said axle sleeve, said axle being formed with a wheel-mounting portion that is disposed in said generator chamber; and
a light-generating unit including a magnet wheel disposed in said generator chamber and mounted coaxially and co-rotatably on said wheel-mounting portion of said axle, a coil device disposed in said generator chamber around said magnet wheel and mounted on said pedal body, and a lamp unit connected electrically to said coil device and mounted on said cage member;
wherein rotation of said axle relative to said pedal body results in rotation of said magnet wheel relative to said coil device, thereby inducing electrical currents in said coil device that are provided to said lamp unit so as to enable said lamp unit to generate a light output.

2. The bicycle pedal of claim 1, wherein said generator chamber is formed adjacent to said front end of said axle hole, said axle being further formed with a coupling portion having a first end part that extends out of said rear end of said axle hole and that is adapted to be connected to a crank, and a second end part that is opposite to said first end part, that extends into said axle hole and that is coupled rotatably to said axle sleeve, said wheel-mounting portion having a retaining section coupled to said second end part of said coupling portion and a supporting section extending out of said front end of said axle hole and into said generator chamber for mounting said magnet wheel thereon.

3. The bicycle pedal of claim 2, wherein said retaining section of said wheel-mounting portion is coupled rotatably and coaxially to said second end part of said coupling portion, said bicycle pedal further comprising a speed-increasing mechanism that includes
a set of gear teeth formed in said front end of said axle hole;
a sun gear mounted securely and coaxially on said retaining section of said wheel-mounting portion;
a planet gear carrier mounted on said second end part of said coupling portion; and
at least one planet gear mounted rotatably on said planet gear carrier and meshing with said gear teeth and said sun gear.

4. The bicycle pedal of claim 1, wherein said cage member includes a pair of lateral cage portions that extend parallel to said axle sleeve, that are disposed respectively on opposite lateral sides of said axle sleeve, and that have opposite front and rear ends, and a bridging portion that interconnects said front ends of said lateral cage portions.

5. The bicycle pedal of claim 4, wherein at least one of said lateral cage portions has an outer wall surface formed with a board receiving cavity, said lamp unit including a circuit board received in said board receiving cavity and having at least one lamp mounted thereon.

6. The bicycle pedal of claim 5, further comprising a light-transmissive cover plate mounted on said outer wall surface of said lateral cage portion to cover said board receiving cavity.

7. The bicycle pedal of claim 4, wherein said bridging portion is formed with a lamp-mounting hole, said lamp unit including a lamp mounted in said hole.

8. The bicycle pedal of claim 7, further comprising a light-transmissive cover plate mounted on said bridging portion to close one end of said lamp-mounting hole.

9. The bicycle pedal of claim 1, wherein said generator chamber is formed adjacent to said rear end of said axle hole, said axle being further formed with a pedal coupling portion that extends into said axle hole and that is coupled rotatably to said axle sleeve, said wheel-mounting portion extending rearwardly and coaxially from said pedal coupling portion so as to extend out of said rear end of said axle hole and into said generator chamber, said axle being further formed with a crank coupling portion that extends rearwardly and coaxially from said pedal coupling portion and that is adapted to be secured to a crank, said bicycle pedal further comprising a cover plate mounted on said pedal body to conceal said magnet wheel and said coil device of said light-generating unit, said cover plate being formed with an axle opening for extension of said crank coupling portion therethrough.
